(19) United States
(12) Patent Application Publication
(10) Pub. No.: US 2026/0281571 A1
(43) Pub. Date: Sep. 17, 2026

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: Eiji TAKEUCHI, Kanagawa (JP)

(21) Appl. No.: 19/535,120

(22) Filed: Feb. 10, 2026

(30) Foreign Application Priority Data
Mar. 11, 2025 (JP) 2025-037999

(51) Int. Cl. H04N 25/47

(52) U.S. Cl. CPC H04N 25/47

(57) ABSTRACT

An information processing device includes: a first sensor configured to output an address event signal indicating a position and a time of a pixel in which a change in luminance occurs; and a second sensor configured to read an image signal at a predetermined frame cycle. A first detection result is acquired by detecting a feature point of a subject based on the output of the first sensor, a feature point image is generated using the first detection result when the first detection result satisfies a predetermined standard, and the feature point image is generated preferentially using a second detection result that is a detection result of the feature point based on an output of the second sensor rather than the first detection result when the first detection result does not satisfy the predetermined standard.

### BACKGROUND

### Field of the Technology

The present disclosure relates to an information processing device, an information processing method, and a storage medium, and particularly, relates to feature point detection.

Japanese Patent Laid-Open No. 2020-72317 discloses an event-based sensor that outputs a change in luminance of each pixel as an address event signal in real time.

However, in a technique of the related art disclosed in Japanese Patent Laid-Open No. 2020-72317, when there is no motion in an event-based sensor or a subject, a predetermined feature point cannot be detected.

### SUMMARY

According to an aspect of the present disclosure, an information processing device includes: a first sensor configured to output an address event signal indicating a position and a time of a pixel in which a change in luminance occurs; and a second sensor configured to read an image signal at a predetermined frame cycle. A feature point image generation unit acquires a first detection result by detecting a feature point of a subject based on the output of the first sensor, generates a feature point image using the first detection result when the first detection result satisfies a predetermined standard, and generates the feature point image preferentially using a second detection result that is a detection result of the feature point based on an output of the second sensor rather than the first detection result when the first detection result does not satisfy the predetermined standard.

Further features of the present disclosure will become apparent from the following description of embodiments with reference to the attached drawings.

### BRIEF DESCRIPTION OF THE DRAWINGS

FIG. 1 is a functional block diagram illustrating a configuration example of a feature point detection apparatus according to a first embodiment of the present disclosure.

FIG. 2 is a flowchart illustrating an operation example of a feature point determination unit to execute an information processing method according to the first embodiment.

FIG. 3 is a time chart illustrating an operation example of the feature point detection apparatus according to the first embodiment.

FIG. 4 is a time chart illustrating an operation example of a feature point detection apparatus according to a second embodiment.

FIG. 5 is a flowchart illustrating an operation example of a feature point determination unit according to the second embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

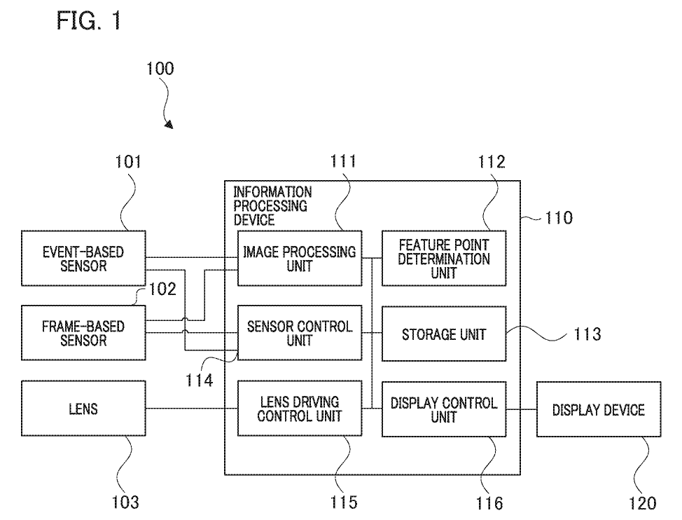

FIG. 1 is a functional block diagram illustrating a configuration example of a feature point detection apparatus 100 according to a first embodiment of the present disclosure. Some of the functional blocks illustrated in FIG. 1 are implemented by causing a CPU or the like serving as a computer (not illustrated) included in the feature point detection apparatus to execute a computer program stored in a memory serving as a storage medium (not illustrated).

However, some or all of the functional blocks may be implemented by hardware. As the hardware, a dedicated circuit (an ASIC), a processor (a reconfigurable processor or a DSP), or the like can be used. Each of the functional blocks illustrated in FIG. 1 may not be housed in the same casing and may be configured by separate apparatuses connected to each other via a signal line.

A feature point detection apparatus 100 according to the present embodiment can be applied to a camera, a smartphone, a head-mounted display, an industrial camera, or the like and can further be applied appropriately to a mobile body such as a mobile robot or an autonomous car.

The feature point detection apparatus 100 can be used appropriately for autofocus, image registration or coordinate conversion in mixed reality (MR) or augmented reality (AR), gesture recognition, eye tracking, or the like by detecting predetermined feature points of a subject.

One or more predetermined feature points detected by the feature point detection apparatus 100 include, for example, at least one of a face, an eye, a hand, and a body of a person, an animal such as a dog or a horse, a vehicle such as a car or a motorcycle, an edge or a corner of a 3-dimensional object, a predetermined pattern (a figure or a design), a predetermined marker, and a predetermined inspection target.

As illustrated in FIG. 1, the feature point detection apparatus 100 includes an event-based sensor 101, a frame-based sensor 102, a lens 103, an information processing device 110, and a display device 120. The event-based sensor 101 includes a plurality of pixels arrayed in a 2-dimensional form.

The event-based sensor 101 detects a change in luminance of each pixel and outputs a position and a time of the pixel in which the change in luminance occurs as an address event signal. Each pixel of the event-based sensor 101 includes a light reception unit configured with a photodiode and a luminance change detection unit.

In the light reception unit of each pixel, the diode converts incident light into a current and a voltage conversion circuit converts the current into a voltage. The converted voltage is compared with a standard voltage in the luminance change detection unit. When a difference exceeds a threshold, an address event signal is output. The event-based sensor 101 functions as a first sensor that outputs an address event signal indicating a position and a time of a pixel in which a change in luminance occurs.

The frame-based sensor 102 is an image sensor that outputs a signal on a frame unit basis. The frame-based sensor 102 includes a plurality of pixels arrayed in a 2-dimensional form. The frame-based sensor 102 may be, for example, any of a color image sensor, a monochromic image sensor, and a ranging sensor.

As the color image sensor or the monochromic image sensor, for example, a CMOS image sensor or a CCD image sensor can be used. In the case of the color image sensor or the monochromic image sensor, a value related to luminance of each pixel is output. As the ranging sensor, a LiDAR or a stereo camera can be used. In the case of the ranging sensor, each pixel outputs a value related to a distance.

The frame-based sensor 102 outputs an imaging signal on the frame unit basis formed by a plurality of pixels for image generation at a given cycle. The frame-based sensor 102 is driven in synchronization with a vertical synchronization signal or the like to achieve the given cycle.

The plurality of pixels for image generation may be all the pixels included in the frame-based sensor 102 or may be a plurality of pixels decimated on a row unit basis from all the pixels included in the frame-based sensor 102.

When the pixels are decimated and read from the frame-based sensor 102, it is preferable that a position of a subject in an image do not become misaligned by also executing corresponding decimation and reading in the event-based sensor 101.

Here, the frame-based sensor 102 functions as a second sensor that reads an image signal at a predetermined frame cycle and reads an output of a plurality of pixels for forming a one-frame image at the frame cycle. In the present embodiment, the number of pixels of the event-based sensor 101 is less than the number of pixels of the frame-based sensor 102.

The lens 103 is provided to adjust an imaging state or an amount of light incident on the event-based sensor 101 or the frame-based sensor 102. When the event-based sensor 101 and the frame-based sensor 102 are provided on different planes, the lens 103 may be individually provided for each sensor.

Alternatively, a part of the lens 103 may be shared and an image may be formed on light reception surfaces of the event-based sensor 101 and the frame-based sensor 102 via a half mirror.

The event-based sensor 101 and the frame-based sensor 102 may be provided on the same plane and share the lens 103. Further, the light reception units of the event-based sensor 101 and the frame-based sensor 102 may be shared and the lens 103 may also be shared. That is, at least some of the plurality of pixels of the event-based sensor 101 and the plurality of pixels of the frame-based sensor 102 may be shared (used in common).

The information processing device 110 is configured with a semiconductor integrated circuit such as an ASIC, includes a CPU serving as a computer and a RAM or a ROM serving as a memory, and further includes a bus. The information processing device 110 is electrically connected to the event-based sensor 101, the frame-based sensor 102, a driving device (not illustrated) of the lens 103, and the display device 120 and is capable of communicating with each of them.

The information processing device 110 may be configured with a plurality of hardware components, as described above, or may be configured by combining, for example, an ASIC and a PC.

The display device 120 displays image information, a feature point image, and the like obtained by the event-based sensor 101 or the frame-based sensor 102. The display device 120 is configured with a liquid crystal display, an organic EL display, or the like.

The information processing device 110 includes an image processing unit 111, a feature point determination unit 112, a storage unit 113, a sensor control unit 114, a lens driving control unit 115, and a display control unit 116. The CPU serving as the computer of the information processing device 110 controls an operation of each unit of the entire device based on a computer program stored in a memory serving as a storage medium.

The image processing unit 111 generates an image from a signal output from the event-based sensor 101 or the frame-based sensor 102 and outputs a detection result related to a predetermined feature point using the image.

That is, an address event signal output from the event-based sensor 101 indicates a position and a time of a pixel in which a change in luminance occurs. Accordingly, the image processing unit 111 can acquire the position of the pixel in which the change in luminance occurs by limiting a time output from the event-based sensor 101 to a certain given period.

The image processing unit 111 generates one black-and-white luminance-change image in which a position of a pixel in which a change in luminance occurs is set to white and a position of a pixel in which no change in luminance occurs is set to black after the position of the pixel is extracted in this way. Here, a method of generating the luminance-change image is not limited thereto, and the number of times the change in luminance occurs within a given period may be counted for each pixel and a luminance-change image multivalued based on the count number may be generated.

Alternatively, a luminance-change image may be generated by distinguishing between positive and negative changes in luminance. Then, the image processing unit 111 executes processing such as object detection using an artificial intelligence (AI) on the generated luminance-change image and executes a first feature point detection operation of outputting a detection result of the feature point.

That is, the image processing unit 111 executes the first feature point detection operation of outputting a detection result of the feature point and acquires a first detection result using the event-based sensor 101 that outputs an address event signal indicating a position and a time of a pixel in which a change in luminance occurs.

Next, the second feature point detection operation executed by the image processing unit 111 of the information processing device 110 will be described. The image processing unit 111 generates one frame image on each frame unit basis using a signal output from the frame-based sensor 102.

Then, the generated frame image is subjected to processing such as object detection executed using an artificial intelligence (AI) and subjected to the second feature point detection operation of outputting a detection result of the feature point. That is, the image processing unit 111 executes the second feature point detection operation of outputting a second detection result of a feature point based on a frame image from the frame-based sensor 102.

The feature point determination unit 112 determines feature points that are a final detection result and generates a feature point image using the determined feature points based on one or both of the first detection result obtained in the first feature point detection operation and the second detection result obtained in the second feature point detection operation. The image processing unit 111 and the feature point determination unit 112 function as a feature point image generation unit.

The number of types of determined feature points may be singular or plural. The types of determined feature points can be determined in advance according to a program. For example, the detected predetermined feature points may be only a predetermined pattern or may be various objects such as people or vehicles.

The number of determined feature points may be singular or plural. For example, when a feature point of an object is detected, a central point of the detected object may be used as the feature point or each vertex of a bounding box of the detected object may be used as the feature point. The number of detected objects may be plural.

The storage unit 113 stores information regarding the feature point determined by the feature point determination unit 112, the feature point image generated by the feature point determination unit 112, or the like. At this time, the information regarding the feature point or the feature point image, and the image generated by the image processing unit 111 may be linked (associated) to be stored in the storage unit 113. The CPU of the information processing device 110 reads information necessary to execute a program stored in advance in the storage unit 113 and the computer program is executed, as described above.

The sensor control unit 114 executes sensor driving control so that the event-based sensor 101 or the frame-based sensor 102 outputs a photoelectric conversion signal. The lens driving control unit 115 executes lens driving control to drive the lens 103. The display control unit 116 executes display control to display information on the display device 120.

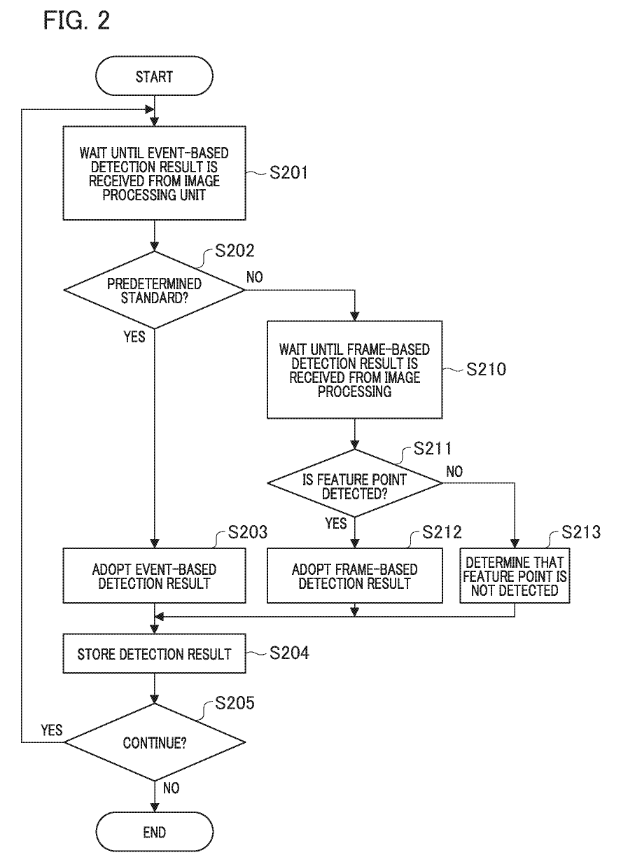

FIG. 2 is a flowchart illustrating an operation example of the feature point determination unit 112 to execute an information processing method according to the first embodiment. An operation of each step of the flowchart of FIG. 2 is executed sequentially by causing the CPU or the like serving as the computer in the information processing device 110 to execute the computer program stored in the memory, and an information processing method is executed using the first and second sensors.

In step S201, the feature point determination unit 112 waits until an event-based detection result is received from the image processing unit 111. That is, the image processing unit 111 acquires the first detection result by detecting a feature point of a subject based on an output of the first sensor, and waits in step S201 until the first detection result is received from the image processing unit 111. When the first detection result is received in step S201 from the feature point determination unit 112, the processing proceeds to step S202.

In step S202, the feature point determination unit 112 determines whether the first detection result satisfies a predetermined standard. When the first detection result satisfies the predetermined standard, the processing proceeds to step S203. When the first detection result does not satisfy the predetermined standard, the processing proceeds to step S210.

The predetermined standard is a standard indicating that the predetermined feature point is detected, as one example. That is, when the predetermined feature point is detected, it is determined that the predetermined standard is satisfied and the processing proceeds to step S203. When the predetermined feature point is not detected, the processing proceeds to step S210.

In step S203, the first detection result obtained in the first feature point detection operation is determined and adopted as a final detection result, the processing proceeds to step S204.

On the other hand, in step S210, the feature point determination unit 112 waits until the second detection result obtained in the second feature point detection operation is received from the image processing unit 111. The processing may return to step S201 during the waiting. When the second detection result is received, the processing proceeds to step S211.

In step S211, the feature point determination unit 112 determines whether the predetermined feature point is detected in the second detection result obtained in the second feature point detection operation. When the predetermined feature point is detected, the processing proceeds to step S212. When the predetermined feature point is not detected, the processing proceeds to step S213.

In step S212, the second detection result obtained in the second feature point detection operation is determined as a final detection result and the processing proceeds to step S204.

The fact that the predetermined feature point is not detected in step S213 is determined as the final detection result, and the processing proceeds to step S204.

In step S204, the final detection result is stored in the storage unit 113 and the feature point image is generated based on the final detection result stored in the storage unit 113. Thereafter, the processing proceeds to step S205.

In step S205, it is determined whether the processing of the feature point determination unit 112 continues. When the processing continues, the processing proceeds to step S201. When the processing does not continue, the processing flow of FIG. 2 ends. In this case, the processing flow of FIG. 2 is periodically executed. When the processing of step S204 ends, the processing may proceed to step S201.

In this way, in the present embodiment, the first detection result is acquired by detecting the feature point of the subject based on the output of the first sensor. When the first detection result satisfies the predetermined standard, the feature point image is generated using the first detection result.

Conversely, when the first detection result does not satisfy the predetermined standard, the feature point image is generated by preferentially using the second detection result that is a detection result of the feature point based on the output of the second sensor than the first detection result.

To specifically describe effects of the present embodiment, an example in which the feature point detection apparatus 100 is, for example, a camera and a user of the feature point detection apparatus 100 captures an image while focusing a person as a subject will be described.

It is assumed that the event-based sensor 101 and the frame-based sensor 102 receive light through the common lens 103 and positions of the lens 103 at which focusing is achieved on the light reception surfaces of the event-based sensor 101 and the frame-based sensor 102 are the same.

In this case, when the user acquires an image captured by the frame-based sensor 102, a focus adjustment operation is executed to achieve focusing on the light reception surface of the event-based sensor 101.

When a person that is a subject is moving and there is a difference in luminance between the person and the background in step S201, the luminance of pixels around the contour of the person in the event-based sensor 101 changes. Based on the address event signal output during this period, the contour of the person is depicted in a luminance-change image generated by the image processing unit 111.

Then, the image processing unit 111 detects the person as a feature point from the luminance-change image and outputs the feature point as a detection result to the feature point determination unit 112. As a result, in FIG. 2, the processing proceeds from step S201 to step S202.

When the predetermined standard in step S202 is detection of the person as the feature point, the standard is satisfied, and thus the processing proceeds to step S203. In step S203, the detected person is determined as the final detection result.

In step S204, information regarding the detected person is stored in the storage unit 113. The stored information is information regarding a position of the detected person in the event-based sensor 101 and is, for example, a position of a vertex of a bounding box of the detected person. In step S204, a feature point image is generated further based on the final detection result stored in the storage unit 113.

The processing proceeds to step S205. When the camera is in an ON state, the processing proceeds to step S201 to repeat steps S201, S202, S203, S204, and S205.

During the repetition, the lens driving control unit 115 controls the lens 103 such that focusing is achieved at the position of the person specified in the feature point image stored in the storage unit 113. In this way, the control can be executed such that focusing is continuously achieved on the person that is a subject. At this time, an aperture or accumulation time is controlled such that an exposure state of the person specified in the feature point image is optimized.

Conversely, when there is no movement in the event-based sensor 101 and the subject, no change occurs in luminance around the contour of the person and the person that is the predetermined feature point is not detected in some cases in step S202.

Even in this case, according to the present disclosure, a detection result of the predetermined feature point is obtained based on the output of the frame-based sensor 102 through steps S210, S211, S212, or S213.

This is an effect obtained by preferring the second detection result obtained in the second feature point detection operation when it is determined in step S202 that the first detection result obtained in the first feature point detection operation does not satisfy the predetermined standard. Accordingly, the lens 103 can be continuously controlled such that focusing is achieved on the person that is the subject specified in the feature point image.

The display control unit 116 can cause the display device 120 to display a subject image generated by the image processing unit 111 or a feature point image that is a detection result determined by the feature point determination unit 112. Accordingly, the user can continuously check whether the predetermined feature point of the subject is detected.

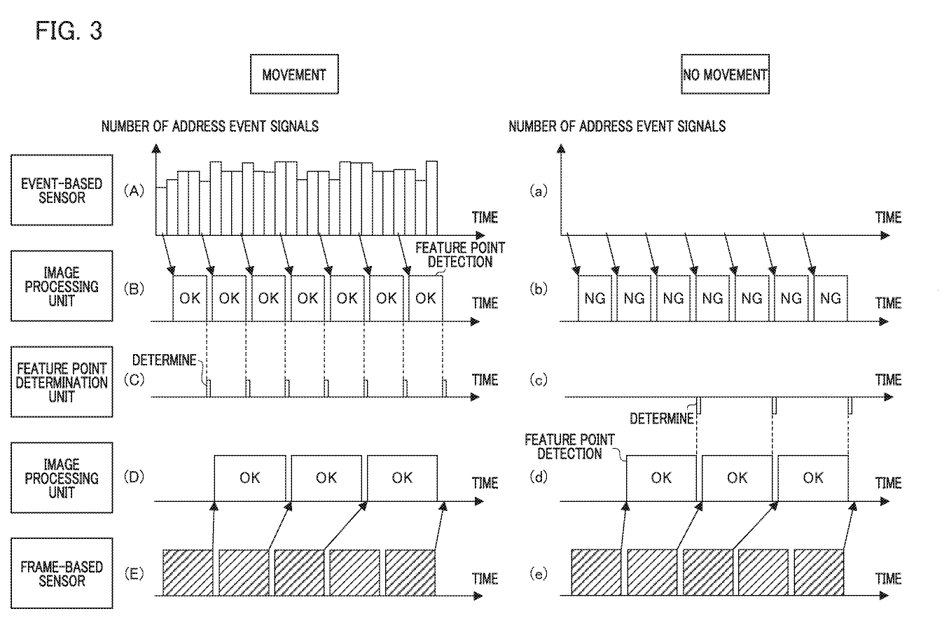

(A) to (E) and (a) to (e) of FIG. 3 are time charts illustrating an operation example of the feature point detection apparatus according to the first embodiment. (A) to (E) of FIG. 3 illustrate an operation example of a case where there is a movement in the event-based sensor 101 or the subject. (a) to (e) of FIG. 3 illustrate an operation example of a case where there is no movement in the event-based sensor 101 or the subject.

(A) and (a) of FIG. 3 illustrate the number of address event signals in the event-based sensor 101. In (A) of FIG. 3, the event-based sensor 101 continuously outputs the address event signal.

Conversely, in (a) of FIG. 3, the event-based sensor 101 does not output the address event signal. (B) and (b) of FIG. 3 illustrate feature point detection in the image processing unit 111. In (B) of FIG. 3, the image processing unit 111 continuously detects the predetermined feature point based on an output of the event-based sensor 101. Conversely, in (b) of FIG. 3, the image processing unit 111 cannot continuously detect the predetermined feature point based on the output of the event-based sensor 101.

(E) and (e) of FIG. 3 illustrate an output of an image for each frame in the frame-based sensor 102. (D) and (d) of FIG. 3 illustrate feature point detection based on the output of the frame-based sensor 102 in the image processing unit 111. In both of (D) and (d) of FIG. 3, the image processing unit 111 continuously detects the predetermined feature point based on the output of the frame-based sensor 102.

(C) and (c) of FIG. 3 illustrate feature point determination in the feature point determination unit 112. A rectangle on the upper side of a time axis indicates that a feature point is determined through the first feature point detection operation. A rectangle on the lower side of the time axis indicates that a feature point is determined through the second feature point detection operation.

In (C) of FIG. 3, a feature point is determined immediately after the feature point is detected through the first feature point detection operation. On the other hand, in (c) of FIG. 3, a feature point is determined immediately after the feature point is detected through the second feature point detection operation.

A time interval of the feature point determination in (C) and (c) of FIG. 3 is preferably short. This is because a delay time can be reduced when position alignment of an image, coordinate conversion, gesture recognition, eye tracking, or the like in autofocus, mixed reality (MR), or augmented reality (AR) is controlled based on the feature point detected by the feature point detection apparatus 100.

Accordingly, in order to track a moving subject in a short time, the event-based sensor 101 outputting the address event signal of only a pixel in which a change in luminance occurs is more preferable to the frame-based sensor 102 outputting all the pixels.

An output time of the sensor and a processing time in the image processing unit 111 become shorter when the number of pixels to be processed is small. In the present embodiment, the number of pixels of the event-based sensor 101 is less than the number of pixels of the frame-based sensor 102, and a detection time of the subject by the first feature point detection operation is shorter than a detection time by the second feature point detection operation.

That is, it is more preferable that a detection time of the feature point of the subject based on an output of the first sensor is shorter than a detection time of the feature point based on an output of the second sensor.

FIG. 3 illustrates an example in which the outputs of the event-based sensor 101 and the frame-based sensor 102 and the processing of the image processing unit 111 are executed in parallel, and a processing time of the image processing unit 111 is a main factor for determining the time interval of the feature point determination is illustrated.

The predetermined standard in step S202 of the flowchart in FIG. 2 may be a standard indicating that reliability of the detected feature point is a predetermined value or more. The reliability of the feature point is, for example, reliability of a result of AI-based object detection.

In the AI-based object detection, for example, the reliability can be quantified, for example, reliability of 90% of a person. In this case, the remaining 10% indicates a possibility of a result of the object detection being incorrect. When the reliability of the predetermined feature point is a standard or more, the processing may proceed from step S202 to step S203. When the reliability of the predetermined feature point is less than the standard, the processing may proceed from step S202 to S210.

Alternatively, the predetermined standard in step S202 may be a standard related to types or the number of predetermined feature points. For example, it is assumed that the feature point detection apparatus 100 is a camera and a user of the feature point detection apparatus 100 desires to focus on a vehicle that is a subject.

In this case, it is preferable to detect one or more vehicles. When one or more vehicles are not detected through the first feature point detection operation, it is preferable to use the second feature point detection operation. With respect to the number, any range can be set as a standard. For example, when a gesture by both hands of the subject is recognized using the feature point detection apparatus 100, it is preferable to set detection by two hands as the predetermined standard.

The setting related to the predetermined standard in step S202 may be stored in advance as a program or a user may be allowed to be able to selector set the predetermined standard using an operation unit (not illustrated) of the feature point detection apparatus 100.

### Modified Examples

Further, a target preferring the second detection result by the second feature point detection operation may be a part of a subject for which the first detection result satisfies the predetermined standard. For example, it is assumed that the feature point detection apparatus 100 is a camera and the user of the feature point detection apparatus 100 desires to focus on a person riding a motorcycle.

It is assumed that the first feature point detection operation has higher person detection accuracy than the second feature point detection operation and has lower detection accuracy than the second feature point detection operation. In this case, in order to detect both the person and the motorcycle with high accuracy, it is preferable to detect each of the person and the motorcycle with higher accuracy.

Accordingly, in the above case, it is preferable to detect the person through the first feature point detection operation and detect the motorcycle through the second feature point detection operation. A first example of a specific procedure for this will be described as a modified example of the flowchart in FIG. 2.

In this case, in step S202, the predetermined standard is that both the person and the motorcycle are detected with given reliability or more through the first feature point detection operation. For example, in step S202, when the detection of the person satisfies the standard of the reliability and the detection of the motorcycle does not satisfy the standard of the reliability, the processing proceeds to step S210.

The second detection result in the second feature point detection operation in step S210 is obtained and the processing proceeds to step S211. In step S211, the motorcycle is detected and the processing proceeds to step S212. It is assumed that the reliability of the detection of the motorcycle by the second feature point detection operation is higher than the reliability of the detection of the motorcycle by the first feature point detection operation.

In the above modified example, in step S212, detection results of the motorcycle by the first and second feature point detection operations may be compared with each other and a detection result with higher reliability may be selected finally. In the present modified example, in step S212, the first detection result in the first feature point detection operation and the second detection result in the second feature point detection operation are both used as final detection results.

That is, the detection result of the person by the first feature point detection operation and the detection result of the motorcycle by the second feature point detection operation are both used as final detection results. In the above modified example, only for the detection result of the motorcycle, the second detection result in the second feature point detection operation is preferred than the first detection result in the first feature point detection operation.

The preference of the second detection result means using of the second detection result instead of the first detection result. Alternatively, alpha blending of the first and second detection results may be executed and a weight of the second detection result may be set to be greater than a weight of the first detection result.

In this way, according to the present embodiment, even when there is no movement in the event-based sensor or the subject, the predetermined feature point can be detected. Further, by appropriately using the feature point detection operation according to a type of subject, it is possible to detect a feature point of a predetermined subject desired by the user with higher accuracy.

### Second Embodiment

A second embodiment is an embodiment in which a feature point can be determined at a higher speed than in the first embodiment. A plurality of examples will be described below. Description of points common to the first embodiment will be omitted.

In the second embodiment, the predetermined standard in step S202 of the flowchart in FIG. 2 is assumed to be a standard indicating that the number of address event signals per unit time is equal to or greater than a predetermined number. When the number of address event signals per unit time is equal to or greater than the predetermined number, the processing proceeds to step S203. When the number of address event signals per unit time is less than the predetermined number, the processing proceeds to step S210.

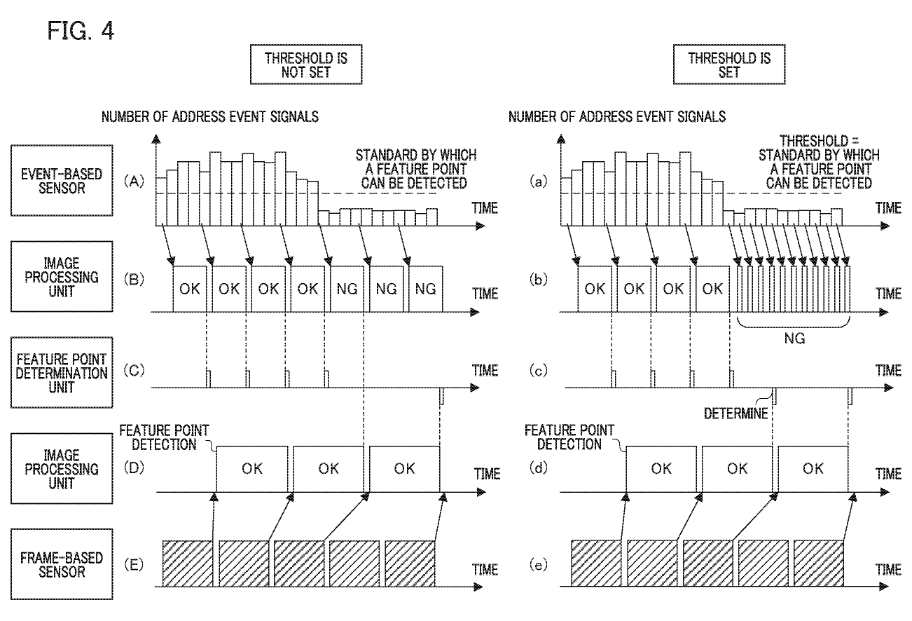

(A) to (E) and (a) to (e) of FIG. 4 are time charts illustrating an operation example of the feature point detection apparatus according to the second embodiment and illustrate modified examples of the first embodiment illustrated in FIG. 3. In (A) to (E) of FIG. 4, a threshold for the number of address event signals per unit time is not set.

Accordingly, as in the first embodiment, the predetermined standard in step S202 is a standard by which a predetermined feature point can be detected, and whether the predetermined feature point can be detected is determined by executing processing for a predetermined time in the image processing unit.

On the other hand, in (a) to (e) of FIG. 4, a threshold for the number of address event signals per unit time is set as the predetermined standard in step S202. That is, the predetermined standard in step S202 is the number of address event signals per unit time. Here, the unit time is defined as a time in which one vertical bar illustrated in (A) and (a) of FIG. 4 is a unit.

In (A) and (a) of FIG. 4, a standard by which a feature point can be detected is indicated by a dashed line. It is assumed that a feature point is detected when the number is equal to or greater than the standard indicated by the dashed line, and a feature point is not detected when the number is not satisfied.

Accordingly, as illustrated in (B) of FIG. 4, in order to determine whether the feature point can be detected, the image processing unit 111 executes object detection processing based on an output of the event-based sensor 101. Therefore, a predetermined processing time is required even when a feature point cannot be detected.

Conversely, in an example illustrated in (b) of FIG. 4, a threshold for the number of address event signals per unit time is set. Accordingly, during a period in which the threshold is not satisfied, it can be determined that the feature point cannot be detected even when the image processing unit 111 does not execute determination processing for detecting an object based on an output of the event-based sensor 101 for a predetermined time as described above.

Accordingly, when the number of address event signals serving as the predetermined standard in step S202 is less than the predetermined threshold, the feature point based on the output of the frame-based sensor 102 can be adopted without waiting for the above processing for the predetermined time in the image processing unit 111.

That is, as illustrated in (c) of FIG. 4, the number of times the feature point is determined in the feature point determination unit 112 is greater than in (C) of FIG. 4, and the feature point based on the output of the frame-based sensor 102 can be determined at a high speed.

In the first embodiment, in step S210 of FIG. 2, the processing waits until a new detection result obtained in the second feature point detection operation is received. However, a detection result of an immediately previous frame obtained in the second feature point detection operation and stored in the storage unit 113 may be used without waiting in step S210.

That is, when the second detection result of the immediately previous frame obtained in the second feature point detection operation and stored in the storage unit 113 is used, a waiting time until reception of the new detection result can be reduced and the feature point can be determined fast.

According to a length of the waiting time expected in step S210, it may be determined whether to use the second detection result of the immediately previous frame obtained in the second feature point detection operation and stored in the storage unit 113 or the second detection result of the new frame obtained in the second feature point detection operation.

When the waiting time expected in step S210 is long, it is preferable to use the second detection result of the stored immediately previous frame obtained in the second feature point detection operation. Conversely, when the waiting time expected in step S210 is short, it is preferable to wait and use a new second detection result.

For example, in (B) of FIG. 4, immediately after a period in which the feature point is detected in the first feature point detection operation, the feature point can no longer be detected in the second feature point detection operation. In this case, it is preferable to use the second detection result of the immediately previous frame obtained in the second feature point detection operation and stored in the storage unit 113.

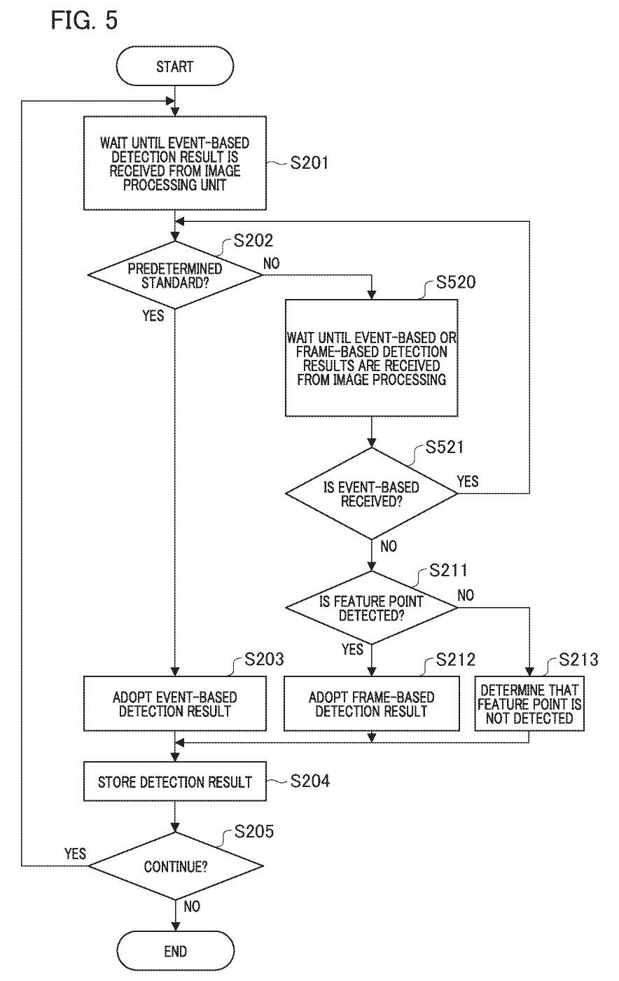

FIG. 5 is a flowchart illustrating an operation example of the feature point determination unit 112 according to the second embodiment and illustrates a modified example of FIG. 2. An operation of each step of the flowchart of FIG. 5 is executed sequentially by causing the CPU or the like serving as the computer in the information processing device 110 to execute the computer program stored in the memory, and an information processing method is executed using the first and second sensors.

Steps S201 to S205 and steps S211 to S213 are the same as those described in FIG. 2, but differ in that the processing proceeds to step S520 when the predetermined standard in step S202 is not satisfied.

In step S520, the processing waits until a detection result is received from either the first feature point detection operation or the second feature point detection operation. The processing proceeds to step S521 when the detection result is received from either operation. The processing proceeds to step S202 when the first detection result is received from the first feature point detection operation in step S521. The processing proceeds to step S211 when the second detection result is received from the second feature point detection operation.

That is, in step S210 of FIG. 2, the processing waits until the second detection result obtained in the second feature point detection operation is received from the image processing unit 111. In step S510, however, the processing returns to step S202 when the first detection result obtained in the first feature point detection operation is received.

When it is determined that the predetermined standard is satisfied in step S202, the processing proceeds to steps S203 and S204. That is, the detection result of the feature point can be updated promptly based on the first detection result obtained in the first feature point detection operation without waiting the second detection result obtained in the second feature point detection operation.

### Third Embodiment

In a third embodiment, power consumption is reduced more than in the first embodiment. Description of points common to the first embodiment will be omitted.

In the first embodiment, as in FIG. 3, the image processing unit 111 processes the outputs of the event-based sensor 101 and the frame-based sensor 102 in parallel, and the frame-based sensor 102 operates normally.

In the third embodiment, the sensor control unit 114 switches between ON and OFF of the operation of the frame-based sensor 102 and the image processing unit 111 selectively processes the outputs of the event-based sensor 101 and the frame-based sensor 102.

The third embodiment will be described with reference to the flowchart of FIG. 2. When the flowchart starts, the operation of the frame-based sensor 102 turns off. When the processing proceeds to steps S201 to S205, the operation of the frame-based sensor 102 remains off.

On the other hand, when the processing proceeds from step S202 to S210, the operation of the frame-based sensor 102 turns on via the sensor control unit 114 and processing proceeds from steps S210 to S212 or S213. After step S212 or S213, the frame-based sensor 102 turns off via the sensor control unit 114 and the processing proceeds to step S205.

As described above, in the third embodiment, while the output of the event-based sensor 101 is processed, low-power consumption can be achieved by turning the operation of the frame-based sensor 102 off.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the information processing device or the like through a network or various storage media. Then, a computer (or a CPU, an MPU, or the like) of the information processing device or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-037999, filed on Mar. 11, 2025, which is hereby incorporated by reference herein in its entirety.

What is claimed is:

1. An information processing device comprising:
a first sensor configured to output an address event signal indicating a position and a time of a pixel in which a change in luminance occurs;
a second sensor configured to read an image signal at a predetermined frame cycle;
at least one processor; and
a memory coupled to the at least one processor, the memory storing instructions that, when executed by the at least one processor, cause the at least one processor to:
acquire a first detection result by detecting a feature point of a subject based on the output of the first sensor,
generate a feature point image using the first detection result when the first detection result satisfies a predetermined standard, and
generate the feature point image preferentially using a second detection result that is a detection result of the feature point based on an output of the second sensor rather than the first detection result when the first detection result does not satisfy the predetermined standard.

2. The information processing device according to claim 1, wherein a detection time of the feature point of the subject based on the output of the first sensor is shorter than a detection time of the feature point based on the output of the second sensor.

3. The information processing device according to claim 1, wherein the second sensor is one of a color image sensor, a monochromic image sensor, and a ranging sensor.

4. The information processing device according to claim 1, wherein the second sensor reads an output of a plurality of pixels for forming a one-frame image at the frame cycle.

5. The information processing device according to claim 1, wherein the predetermined standard is a standard indicating that the feature point is detected.

6. The information processing device according to claim 1, wherein the predetermined standard is a standard indicating that reliability of the detected feature point is equal to or greater than a predetermined value.

7. The information processing device according to claim 1, wherein the predetermined standard is a standard related to a type or the number of feature points.

8. The information processing device according to claim 1, wherein the predetermined standard is a standard indicating that the number of address event signals per unit time is equal to or greater than a predetermined number.

9. The information processing device according to claim 1, wherein a target for which the second detection result is preferred is a part of the subject for which the first detection result satisfies the predetermined standard.

10. An information processing method of using a first sensor outputting an address event signal indicating a position and a time of a pixel in which a change in luminance occurs and a second sensor reading an image signal at a predetermined frame cycle, the method comprising:
acquiring a first detection result by detecting a feature point of a subject based on the output of the first sensor,
generating a feature point image using the first detection result when the first detection result satisfies a predetermined standard, and
generating the feature point image preferentially using a second detection result that is a detection result of the feature point based on an output of the second sensor rather than the first detection result when the first detection result does not satisfy the predetermined standard.

11. A non-transitory computer-readable storage medium configured to store a computer program to control:
a first sensor configured to output an address event signal indicating a position and a time of a pixel in which a change in luminance occurs; and
a second sensor configured to read an image signal at a predetermined frame cycle,
wherein the computer program comprises instructions for executing the following processes of
acquiring a first detection result by detecting a feature point of a subject based on the output of the first sensor,
generating a feature point image using the first detection result when the first detection result satisfies a predetermined standard, and
generating the feature point image preferentially using a second detection result that is a detection result of the feature point based on an output of the second sensor rather than the first detection result when the first detection result does not satisfy the predetermined standard.
